(19) United States
(12) Patent Application Publication
(10) Pub. No.: US 2008/0250817 A1
(43) Pub. Date: Oct. 16, 2008

(54) Method and Apparatus for Manufacturing an Optical Fiber Preform

(75) Inventors: Emmanuel Petitfrere, Villeneuve d'Ascq (FR); Laurent Calvo, Carvin (FR)

Correspondence Address: SUMMA, ALLAN & ADDITON, P.A., 11610 NORTH COMMUNITY HOUSE ROAD, SUITE 200, CHARLOTTE, NC, 28277, US

(73) Assignee: DRAKA COMTEQ B.V., Amsterdam (NL)

(21) Appl. No.: 12/056,988

(22) Filed: Mar. 27, 2008

(30) Foreign Application Priority Data
Mar. 27, 2007 (FR) 07/02226

(51) Int. Cl. C03B 37/00

(52) U.S. Cl. 65/391

(57) ABSTRACT

The invention embraces a method for manufacturing an optical fiber preform. The primary preform is overcladded by projecting silica grain under a plasma torch, wherein, during overcladding, at least one region adjacent to the plasma torch is cooled by gas provided by at least one cooling nozzle. The invention facilitates low-cost preform overcladding in a way that limits the incorporation of impurities into the silica overcladding.

### CROSS-REFERENCE TO PRIORITY APPLICATION

This application claims the benefit of pending French application Ser. No. 07/02226 (filed Mar. 27, 2007, at the French Patent Office for “Method and Apparatus for Manufacturing an Optical Fiber Preform”), which is hereby incorporated by reference in its entirety.

### FIELD OF THE INVENTION

The present invention relates to a method for manufacturing an optical fiber preform.

### BACKGROUND OF THE INVENTION

An optical fiber is formed by drawing an optical preform on a drawing tower. An optical preform generally includes a primary preform, which itself includes a silica tube of pure or doped silica in which doped and/or pure silica layers have been successively deposited. (These layers become the optical fiber's inner cladding and a central optical core.) The primary preform is typically overcladded or sleeved to increase its diameter, thereby forming a final preform that, on a drawing tower, can be drawn into optical fiber. In this context, the term “inner cladding” refers to the optical cladding formed inside the silica tube, and the term “outer cladding” refers to the optical cladding formed on the outside of the silica tube.

The homothetic optical fiber drawing operation includes placing the optical preform vertically in a tower and drawing an optical fiber strand from one end of the optical preform. For this purpose, high heat is applied to an end of the preform until the silica softens. To achieve an optical fiber of a particular diameter, the drawing speed and temperature are continuously controlled during the drawing operation.

An optical fiber conventionally includes an optical core, which functions to transmit and, optionally, to amplify an optical signal, and an optical cladding, which functions to confine the optical signal within the optical core. For this purpose, the refractive index of the optical core (n_{c}) is greater than the refractive index of the optical cladding (n_{g}) (i.e., n_{c}>n_{g}). As is well known, the propagation of an optical signal in a single mode optical fiber decomposes into a fundamental mode guided in the optical core and into secondary modes (i.e., cladding modes) guided over a certain distance in the optical core-optical cladding assembly.

A silica tube may be made according to chemical vapor deposition (CVD), such as described in U.S. Pat. No. 3,907,536, which is hereby incorporated by reference in its entirety. This kind of deposition is performed by injecting gas mixtures in a glass substrate tube and then ionizing the gas mixtures. As will be known by those having ordinary skill in the art, chemical vapor deposition encompasses modified chemical vapor depositions (MCVD), furnace chemical vapor depositions (FCVD), and plasma-enhanced chemical vapor depositions (PCVD). The PCVD method is described, for example, in U.S. Pat. No. 4,145,456, which is hereby incorporated by reference in its entirety.

After depositing the glass layers corresponding to the optical core and the inner cladding, the silica tube is closed upon itself in a so-called collapsing operation to obtain a primary preform (i.e., a silica rod). This primary preform is then overcladded to increase its diameter, typically using relatively inexpensive natural silica grain.

The overcladding may be carried out by plasma deposition in which the natural silica grain is projected on the primary preform and, via a plasma torch, are fused at a temperature of about 2,300° C. The natural silica grain is vitrified on the periphery of the primary preform to form an outer optical cladding. During the overcladding process, the primary preform is caused to rotate around its longitudinal axis and the plasma torch and/or the primary preform move longitudinally with respect to each other. Such rotational and translational movement facilitates uniform silica deposition over the periphery of the primary preform.

The overcladding operation is generally carried out in a closed cabin with a controlled atmosphere so as to provide protection against electromagnetic perturbations and the evolvement of ozone emitted by the plasma torch.

The overcladding by plasma deposition of silica grain may be relatively inexpensive, but it produces impurities that are deposited on the periphery of the primary preform. These impurities (e.g., water or dust particles) derive from the ambient air of the cabin in which the overcladding operation is conducted. In particular, during the overcladding operation, the silica is brought to its vitrification temperature by the plasma torch, at which point the silica is in a transition state tending to promote the absorption of OH-group impurities from water. The presence of impurities in the outer cladding—formed by the overcladding—deteriorates the optical properties of the optical fiber, especially when impurities are present in the first layers of silica deposited onto the primary preform.

This problem of impurities becoming incorporated into the overcladding increases as the diameter of the primary preform's central optical core increases. With a large-diameter central optical core, the inner cladding has a limited thickness. Consequently, the impurities incorporated in the periphery of the silica tube during overcladding adversely influence the signal propagation in the central optical core. This adverse influence becomes more pronounced the closer the impurities are to the optical core.

Those having ordinary skill in the art will appreciate that the diameter of the primary preform is the sum of the diameter of the optical core and the width of the inner cladding. The diameter of the final preform is the diameter of the primary preform plus the width of the overcladding (i.e., the thickness of the outer optical cladding). The ratio of the diameter of the optical core to the width of the optical cladding (i.e., inner+outer cladding) should be kept constant.

If the diameter of the final preform is to be enlarged, then both the diameter of the optical core and the width of the optical cladding must be increased. Moreover, if the diameter of the primary preform is to be maintained, then the width of the inner cladding must be decreased (i.e., to offset the required increase in outer cladding width). Decreasing the width of the inner cladding, however, causes the outer cladding to come closer to the optical core. Consequently, impurities in the outer cladding have a greater influence upon the optical core, especially impurities in the initial layers of the outer cladding, which are positioned most closely to the inner cladding.

It is sought to manufacture large capacity preforms. The capacity of a preform refers to the length of optical fiber that can be drawn from the preform. The greater the diameter of the preform, the greater its capacity. To reduce manufacturing costs and to limit connection losses, which are inherent when optical fibers are to be connected to each other, it is desirable to provide long lengths of optical fibers from the same preform.

Therefore, it is sought to fabricate large diameter preforms while respecting the relative dimensional constraints between the diameter of the central optical core and the diameter of the optical cladding (i.e., inner+outer cladding). Those having ordinary skill in the art will understand that the final preform (i.e., after overcladding) must possess the optical core diameter/optical cladding diameter ratio that is desired for the resulting, drawn optical fiber.

To manufacture a large capacity preform, it is generally chosen to increase the quantity of overcladding rather than increasing the diameter of the primary preform, which is a costly unit operation. To increase the quantity of overcladding while keeping the ratio of the optical core to optical cladding constant, it is required that the optical core, which is formed by deposition inside the silica tube, be enlarged. This means that, to keep the diameter of the primary preform the same, the width of the inner cladding must be decreased.

U.S. Patent Application Publication No. 2002/0144521, which is hereby incorporated by reference in its entirety, describes a method for manufacturing a large capacity preform. In order to solve the aforementioned impurities problem, this publication proposes making a primary preform by depositing a large diameter central optical core inside a silica tube doped with chlorine and fluorine. The silica tube is doped with chlorine to limit the migration of OH-group impurities, which deteriorates the optical transmission properties in the central optical core. The silica tube is doped with fluorine, which reduces refractive index, to compensate for the increase in the refractive index caused by the chlorine doping.

The use of such a silica tube doped with chlorine and fluorine makes it possible to reduce the thickness of the inner cladding deposited in the silica tube and to fabricate a primary preform having an enlarged central optical core diameter. This primary preform is then overcladded by plasma deposition to obtain a final preform of large diameter and, hence, of large capacity. The silica tube doped with chlorine and fluorine protects the central optical core against impurities caused by the overcladding process using natural silica grain. This method, however, requires the use of a specific kind of silica tube that is more costly than a pure silica tube. Moreover, the presence of chlorine in the silica tube does not prevent the formation of Si—OH bonds on the silica tube surface during the overcladding.

French Patent Application No. FR 2,760,449, and its counterpart U.S. Pat. No. 6,477,864, which is hereby incorporated by reference in its entirety, describes a method for depositing silica on an optical fiber primary preform. This application proposes purifying the natural silica that is deposited during the overcladding operation. A supply duct supplies a gaseous mixture containing chlorine or fluorine in the vicinity of the plasma torch. This causes the alkaline elements or alkaline-earth elements contained in the silica grain to react, thereby reducing the formation of OH-groups in the overcladding formed on the primary preform.

The present inventors, however, have discovered that it is not at the area covered by the plasma torch (i.e., the portion of the preform that is being directly heated by the plasma torch) where impurities are incorporated into the overcladding silica. The temperature under the plasma torch is approximately 2,300° C., which is too high to promote the formation of bonds with the OH-groups. Rather, it has been discovered that the impurities are especially deposited in the uncooled silica that has just been vitrified on the surface of the silica tube. Consequently, the introduction of a gaseous mixture containing chlorine or fluorine at the preform area directly heated by the plasma torch does not sufficiently reduce the formation of impurities in the overcladding silica.

French Patent Application No. FR 2,647,778 and its U.S. counterpart U.S. Pat. No. 5,194,714, which is hereby incorporated by reference in its entirety, describe a method and device for depositing silica on an optical-fiber primary preform. The silica rod forming the primary preform is placed on a glass-working lathe in a sealed chamber. The overcladding operation is conducted in this sealed chamber, which is separated from the ambient atmosphere and supplied with dried gas. The air in the chamber is successively filtered, compressed, and refrigerated, purged with condensed water, and desiccated by adsorption. With such a procedure, it is theoretically possible to suppress most of the impurities that are likely to be incorporated into the overcladding silica. This solution, however, is complex and costly to implement. For instance, the chamber volume must be at least 8 to 10 m³ and requires an airflow rate through the chamber of about 3000 cubic meters per hour. Subjecting such an air volume to such filtering and drying operations represents a costly implementation that is incompatible with manufacturing costs for optical fibers.

Japanese Patent Application No. JP 2005-350328, which is hereby incorporated by reference in its entirety, discloses a process for flame polishing a core rod in an oxyhydrogen flame during manufacturing of an optical fiber preform.

Japanese Patent Application No. JP 07-144928, which is hereby incorporated by reference in its entirety, discloses an optical-preform-producing device to produce a thermophoresis effect and increase the soot deposition rate.

Commonly assigned French Patent Application No. FR 0513254, filed Dec. 23, 2005, for a “Method for Manufacturing an Optical Fiber Preform,” and its counterpart U.S. Patent Application Publication No. 2007/0163299, which is hereby incorporated by reference in its entirety, describe a manufacturing method in which the primary preform is positioned in a silica tube delimiting a control volume of reduced size around the overcladding area. In this way, the atmosphere is controlled solely in this reduced volume delimited by the silica tube rather than in the entire volume of a chamber containing the glass-working lathe.

There is, therefore, a need for a method for manufacturing an optical fiber preform that facilitates a low-cost overcladding operation that limits the incorporation of impurities in the overcladding silica.

### SUMMARY OF THE INVENTION

Accordingly, the present invention proposes a solution that includes overcladding a primary preform while cooling at least one zone of the preform adjacent to the zone covered by the plasma torch.

In this regard, the term “zone” refers to a portion or area around the periphery of the preform. The silica grain is projected into the flame of the plasma torch to form the overcladding. The silica grain reaches vitrification temperature even though the preform itself is cooled just beside the plasma torch. This adjacent cooling of the preform is typically focused in a zone downstream from the silica-grain deposition in order to limit the absorption of OH-group impurities by the deposited silica. As used herein with respect to the overcladding method according to the present invention, the term “downstream” refers to a lagging position relative to the lateral movement of the plasma torch (i.e., where silica-grain deposition has just occurred rather than a leading position where silica-grain deposition will occur next).

In one aspect, the invention embraces a method for manufacturing an optical fiber final preform that includes overcladding a primary preform by projecting silica grain under a plasma torch, wherein the primary preform and/or the plasma torch move along the longitudinal axis of the primary preform in translation (i.e., substantially parallel) with respect to each other, and wherein at least one zone of the preform adjacent to the zone covered by the plasma torch is cooled during the overcladding (e.g., by at least one cooling nozzle providing cooling gas). In this regard, the phrase “zone covered by the plasma torch” refers to that portion or area around the periphery of the preform that is being directly heated by the plasma torch and onto which the silica grain is being directly projected.

In one embodiment, the method according to the present invention includes one cooling nozzle that blows gas onto a zone of the preform downstream of the plasma torch (i.e., a preform zone onto which silica grain has just been vitrified during the overcladding step).

In one embodiment, the method according to the present invention includes two cooling nozzles that blow gas onto preform zones on either side of the zone covered by the plasma torch. In a related embodiment, at least one cooling nozzle blows air. In another related embodiment, at least one cooling nozzle blows nitrogen, such as more than about 95-percent purity nitrogen.

In another embodiment, the method according to the present invention includes blowing gas by at least one cooling nozzle having a relative humidity of less than 10 percent at 20° C. (e.g., less than 5 percent relative humidity).

In yet another embodiment, the method according to the present invention includes blowing cooling gas having a temperature of between 20° C. and 25° C. onto the preform.

In yet another embodiment, the method according to the present invention includes blowing fluorinated and/or chlorinated gases from at least one cooling nozzle.

In yet another embodiment, the method according to the present invention includes blowing gas from at least one cooling nozzle at a rate of more than about 75 l/min (e.g., more than about 100 l/min), such as at a rate of more than about 150 l/min (e.g., more than about 200 l/min).

In yet another embodiment, the method according to the present invention includes positioning at least one cooling nozzle at a radial distance of between about 15 mm and 60 mm from the periphery (i.e., the outer circumference) of the preform being overcladded.

In yet another embodiment, the method according to the present invention includes positioning at least one cooling nozzle at a longitudinal distance (i.e., laterally) between about 45 mm and 90 mm from the axis of the plasma torch.

In yet another embodiment, the method according to the present invention includes positioning at least one cooling nozzle at a longitudinal distance (i.e., laterally) between about 3 mm and 50 mm from the side of the plasma torch.

In another aspect, the invention embraces an apparatus for manufacturing an optical fiber final preform. The apparatus includes, for example, (i) a support to receive a primary preform (e.g., lathe supports from a glass-working lathe), (ii) a device for overcladding the primary preform (e.g., a plasma torch and a silica-grain feed conduit), and (iii) at least one cooling nozzle adapted to blow gas onto a zone of the preform adjacent to the zone covered by the overcladding device. In particular, the apparatus embraces a glass-working lathe that is capable of moving the primary preform and/or the overcladding device along the longitudinal axis of the primary preform in translation with respect to each other. As noted, the glass-working lathe is also capable of supporting the primary preform during overcladding.

In one embodiment, the apparatus according to the present invention includes two cooling nozzles that are adapted to blow gas on either side of the overcladding device (e.g., the plasma torch and the duct supplying silica grain).

In another embodiment, the apparatus according to the present invention includes a gas-flow controller (e.g., a mass-flow controller or other flow meter) that regulates the flow rate of the gas blown by at least one cooling nozzle.

In yet another embodiment, the apparatus according to the present invention includes a glass-working lathe that (i) moves the primary preform and/or the overcladding device along the longitudinal axis of the primary preform in translation with respect to each other (e.g., using a motor and a spindle) and/or (ii) maintains radial separation between the preform and the overcladding device and/or cooling nozzle(s). For this purpose, the apparatus according to the present invention is typically automated, such as through the integration of one or more programmable logic controllers (PLC) and associated computer programs.

In yet another embodiment, the apparatus according to the present invention employs standard measurement tools, such as rulers or a measurement tape to set (i) the radial distance between the cooling nozzle(s) and the periphery of the primary preform, and/or (ii) the longitudinal distance between the cooling nozzle(s) and the overcladding device (e.g., the plasma torch).

In yet another aspect, the invention embraces an optical fiber drawn from an optical preform achieved in accordance with the method of the present invention.

The foregoing, as well as other objectives and advantages of the invention and the manner in which the same are accomplished, is further specified within the following detailed description and its accompanying drawings.

### BRIEF DESCRIPTION OF THE DRAWINGS

FIG. 1 schematically depicts an exemplary apparatus according to the present invention.

FIG. 2 schematically depicts an optical fiber preform in which sections are cut to measure OH-group concentration in the overcladding silica.

FIG. 3 graphically depicts OH-group concentration as a function of preform diameter for a reference preform and two preforms overcladding in accordance with the present invention.

### DETAILED DESCRIPTION

In one aspect, the present invention embraces a cost-effective method for overcladding a primary preform in a way that reduces the formation of impurities in the outer silica cladding of a final optical preform and its resulting optical fiber.

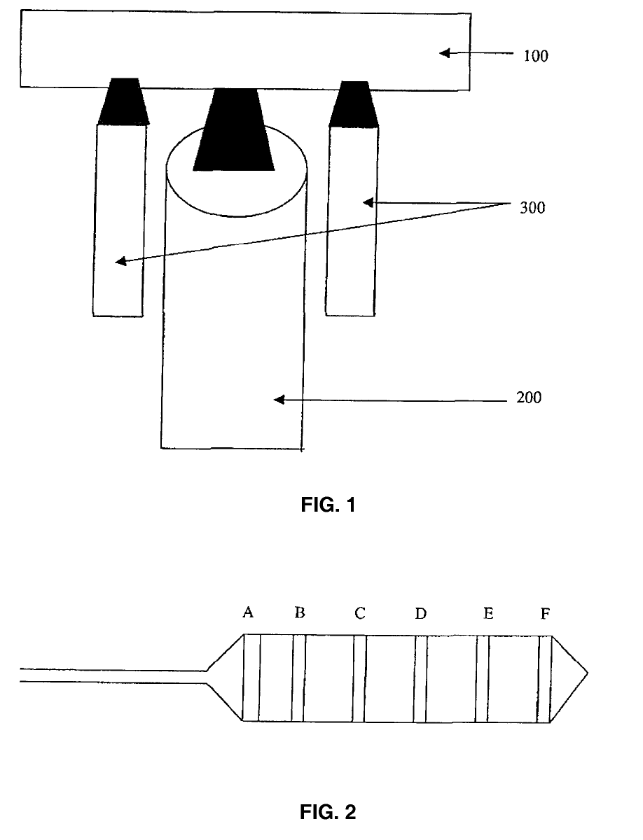

FIG. 1 schematically depicts a primary preform 100 that is to be placed on a glass-working lathe to be overcladded so as to form a final preform from which optical fiber can be drawn. The primary preform 100, which is typically a rod of highly pure silica, may be manufactured according to any known technique (e.g., PCVD). The overcladding can be achieved by plasma deposition of silica grain, typically inexpensive natural silica grain. Depending upon the intended applications of the resulting optical fiber, the silica grain projected for overcladding may also be doped.

A duct feeding silica grain (not illustrated) is provided near the plasma torch 200. Typically, either the overcladding assembly, which may include the plasma torch 200 and a duct supplying silica grain, is moved in a back and forth movement along the rotating primary preform 100, or the rotating primary preform 100 slides in a longitudinal back and forth movement in front of the overcladding assembly (e.g., the plasma torch 200 and the duct supplying silica grain). In addition, both the rotating primary preform 100 and the plasma torch 200 may be moved with respect to each other.

According to the present invention, at least one cooling nozzle 300 is provided to blow gas onto a zone of the preform adjacent the zone covered by the plasma torch 200 (i.e., heated directly). As noted, the absorption of OH-group impurities in the silica is promoted by the transition state of the silica during vitrification. Surprisingly, it has been discovered that if the temperature of the silica that has just been vitrified is cooled below a threshold temperature of about 1300° C., the absorption of OH⁻ impurities into the silica overcladding can be largely reduced.

The invention therefore proposes cooling the preform around (and at least downstream of) the plasma torch 200 by blowing gas just beside the plasma torch 200 during the overcladding operation. As depicted in FIG. 1, two cooling nozzles 300 are positioned on either side of the plasma torch 200. This dual-nozzle configuration further limits the risk of impurities being absorbed in the silica that is heated by the plasma torch 200.

That said, those having ordinary skill in the art will appreciate that a single cooling nozzle 300 can be sufficient if it can be piloted so that it can be positioned downstream of the plasma torch 200 on each overcladding pass (i.e., configured in a lagging position with respect to the movement of the plasma torch 200). Alternatively, two cooling nozzles 300 can operate alternately (i.e., the lagging nozzle 300 cools the silica that has just been vitrified onto the preform 100).

It is particularly sought to cool the preform 100 in a downstream zone adjacent to the zone covered by the plasma torch 200. In this regard, the term “downstream” refers to the movement of the plasma torch 200 along the preform (i.e., the zone cooled by the cooling nozzle 300 is the lagging zone onto which silica grain has just been vitrified by the plasma torch 200). Thus, because the plasma torch 200 performs a back and forth movement along the preform 100, the “downstream” zone of the plasma torch 200 alternates on each overcladding pass.

The cooling nozzle(s) 300 may move with the plasma torch 200 if the plasma torch 200 moves along the rotating preform. The cooling nozzle(s) 300 may also move radially (e.g., outwardly) with respect to the preform 100 to adjust their position relative to the periphery of the preform being overcladded.

In particular, as the overcladding progresses, the cooling nozzle(s) 300 must be moved outwardly so as not to come up against the preform 100, which, of course, enlarges during overcladding. This can be carried out, for example, by moving the glass-working lathe up or down. The cooling nozzle(s) 300 may be integrated on a base shared with the overcladding device, which, as noted, includes the plasma torch 200 and the silica-grain feed duct.

The cooling nozzle(s) 300 may be maintained at a set radial distance from the periphery of the preform being overcladded. A radial distance of between 15 and 60 mm has been observed to provide optimal cooling without disturbing the overcladding.

The glass-working lathe can be moved upwards and downwards during the overcladding process as is necessary to keep the desired radial distance between the preform 100 and the cooling nozzle(s) 300 and/or plasma torch. Those having ordinary skill in the art will understand that maintaining radial separation from the preform can be achieved in various ways, such as using an optical camera or other instrument to measure preform growth.

Similarly, the cooling nozzle(s) 300 may be kept at a given longitudinal distance away from the flame of the plasma torch 200 (e.g., at a lateral distance of between 45 and 90 mm from the axis of the plasma torch 200). The respective cooling nozzles 300 are typically located at a longitudinal distance of between 3 mm and 50 mm from the side of the plasma torch 200. By way of example, the plasma torch 200 may have a radius of 30-80 mm (e.g., 42 mm or so).

Tanks of pressurized air or nitrogen may be connected to the cooling nozzle(s) 300. The gases are typically the same as the gases used for the plasma torch 200. The gases stored for the cooling nozzle(s) 300 have a relative humidity at 20° C. of less than 10 percent, typically less than 5 percent. Moreover, the gases can be mixed with fluorinated and/or chlorinated gases to inhibit the formation of OH-groups near the plasma torch 200 and, thus, the formation of Si—OH bonds on the surface of the preform 100 around the plasma torch 200. Although the blowing of air provided satisfactory results in limiting impurities in the overcladding, blowing nitrogen instead avoids the creation of NOx groups, a greenhouse gas.

The gas blown by the cooling nozzle(s) 300 is, for example at an ambient temperature (i.e., between about 20° C. and 25° C.). Those having ordinary skill in the art will appreciate, however, that cooler or warmer gases can be used provided preform cooling is effected. The gas must function, of course, to cool the preform 100 whose temperature is brought to over 2000° C. by the application of heat from the plasma torch 200. Therefore, the silica is typically cooled rapidly after vitrification so that it remains only a short time in the transition state that has been found to promote the absorption of OH-group impurities (e.g., greater than about 1300° C.). Rapid cooling reduces the absorption of unwanted impurities into the overcladding.

Those having ordinary skill in the art will appreciate that the overcladding method according to the present invention can be readily automated through the implementation of control systems (e.g., integrating PLCs).

Using the method of the invention, the presence of OH-groups in the silica overcladding can be substantially reduced. In this regard, measurements of OH-group concentrations were performed on several sections of different optical fiber preforms. FIG. 2 schematically depicts an optical fiber preform from which sections have been cut. The OH-group concentration can be measured in each section (e.g., using an infrared spectroscopy). The positions referenced as “A” and “F” correspond to weld areas where the preform is welded onto the glass-working lathe support. Six positions are illustrated in FIG. 2, spaced apart by approximately 100 mm for a preform having a length of about 500 mm.

Table I (below) provides the mean concentration of OH-groups in different sections of the overcladding for different preforms as measured between preform diameters of 34 mm and 92 mm. The measurements of OH-group concentrations provided in Table 1 correspond to concentrations of OH-groups in the overcladding; the primary preform has a diameter of 33 mm and the final preform has a diameter of 93 mm.

Table 1 (below) provides a mean measurement of the OH-group concentration for a preform diameter of strictly less than 50 mm (i.e., measurements made between diameters of 34 mm and 49.99 mm) and for a preform diameter of 50 mm or over. This division, though arbitrary, is provided to show the importance of a low level of OH-group impurities near the inner cladding. The respective 500-mm preforms were cut at regular intervals (as shown FIG. 2) to measure the radial concentration of OH-group impurities in the overcladding. Table 1 (below) gives these mean OH-group concentrations in the overcladding for the different sections B to E for both (i) a reference preform and (ii) two preforms obtained via the method of the present invention.

TABLE 1

| | Reference Preform | | Preform I | | Preform II | |
|---|---|---|---|---|---|---|
| | mean [OH] | mean [OH] | mean [OH] | mean [OH] | mean [OH] | mean [OH] |
| | (ppm) | (ppm) | (ppm) | (ppm) | (ppm) | (ppm) |
| | ≦50 mm | >50 mm | ≦50 mm | >50 mm | ≦50 mm | >50 mm |
| Pos. B | 3.01 | 8.85 | 0.27 | 4.18 | 0.44 | 3.68 |
| Pos. C | 3.20 | 8.19 | 0.36 | 3.47 | 0.44 | 3.66 |
| Pos. D | 3.13 | 10.01 | 0.48 | 3.61 | 0.44 | 3.74 |
| Pos. E | 2.93 | 7.49 | 0.43 | 3.34 | 0.52 | 3.79 |

The reference preform was overcladded according to a prior art method (e.g., overcladded by projecting silica grain vitrified onto the preform using a plasma torch in a chamber under controlled atmosphere).

Preform I was overcladded according to the method of the present invention (i.e., by projecting silica grain vitrified onto the preform using a plasma torch 200 and cooling the preform just beside the plasma torch 200). To fabricate Preform I, two cooling nozzles 300 were used to blow nitrogen on either side of the plasma torch 200 at a flow rate of 150 l/min. The cooling nozzles 300 were positioned 10 mm from the edge of the plasma torch 200, approximately 60 mm laterally from the axis of the plasma torch 200 and 25 mm radially from the periphery of the preform during the overcladding operation.

Preform II was overcladded according to the method of the present invention (i.e., by projecting silica grain vitrified onto the preform using a plasma torch 200 and cooling the preform just beside the plasma torch 200). To fabricate Preform II, two cooling nozzles 300 were used to blow nitrogen on either side of the plasma torch 200 at a flow rate of 200 l/min. The cooling nozzles 300 were positioned 10 mm from the edge of the plasma torch 200, approximately 60 mm laterally from the axis of the plasma torch 200 and 25 mm radially from the periphery of the preform during the overcladding operation.

It was found that the mean concentration of OH-groups in the silica overcladding up to a diameter of less than 50 mm (i.e., in the overcladding closest to the optical core) was between 2.93 ppm and 3.20 ppm for the reference preform, was between about 0.27 ppm and 0.48 ppm for Preform I, and was between about 0.44 ppm and 0.52 ppm for Preform II. The reduction of OH-group impurities in the initial overcladding layers is notable using the method of the invention. The OH-group concentration in the preforms of the invention is about six times less (i.e., about one sixth) of that found in the reference preform. As explained, reducing impurities in the first overcladding layers is essential to reduce the risk of migration of these impurities toward the optical core of the optical fiber.

It was further found that the mean concentration of OH-groups in the silica overcladding beyond a diameter of 50 mm is also improved with the method of the present invention. In this regard, the mean concentration of OH-groups was between 7.49 ppm and 10.01 ppm for the reference preform, was between about 3.34 ppm and 4.18 ppm for Preform I, and was between about 3.66 ppm and 3.79 ppm for Preform II.

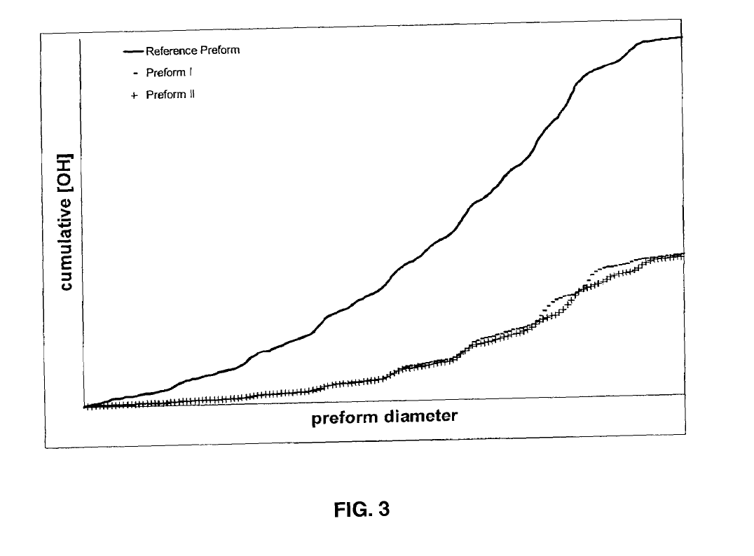

FIG. 3 plots the cumulative OH-group as a function of preform diameter as measured between diameters of 34 mm and 92 mm. The solid line depicts the cumulative OH-group concentration as measured for the reference preform; the dashed line (- - -) depicts the cumulative OH-group concentration as measured for Preform I; the crossed line (+++) depicts the cumulative OH-group concentration as measured for Preform II.

It will be noted from Table I and FIG. 3 that the OH-group concentration in the silica overcladding was substantially reduced in Preform I and Preform II of the present invention as compared with the reference preform. It will be further noted from Table I that Preform II showed a more regular mean OH-group concentration than Preform I (i.e., a smaller difference between the mean concentrations of the different sections measured). This suggests that a greater flow rate of cooling gas directed onto the preform zones adjacent to the plasma torch 200 provides more uniform cooling of the preform.

The method of the invention can be implemented with a relatively uncomplicated apparatus. A conventional glass-working lathe, for example, can be used as a support to receive the primary preform 100. A conventional plasma torch 200 with a duct to supply silica grain can also be provided. At least one cooling nozzle 300 is also provided. The cooling nozzle(s) 300 may be integrated on a support common with the plasma torch 200 or may be installed next to it and controlled separately.

The apparatus may also include a glass-flow controller to regulate the flow rate of the cooling nozzle(s) 300. The apparatus may also include a position controller to control the radial position of the cooling nozzle(s) 300 relative to the periphery of the preform being overcladded and, optionally, to control the longitudinal distance of the cooling nozzle(s) 300 relative to the plasma torch 200 to the extent that the cooling nozzle(s) 300 are not integrated on a common support with the plasma torch 200.

The method and apparatus of the invention can be used for overcladding an optical fiber primary preform to obtain a final preform that is ready for drawing. In accordance with the present invention, this overcladding step can be performed in a room with no atmosphere control, thereby limiting installation costs. It has been unexpectedly found that simply cooling the zones of the preform adjacent to the plasma torch 200 is sufficient to limit the incorporation of OH-group impurities in the overcladding.

Therefore, in accordance with the present invention, overcladding operation of a primary preform can be performed using a simple, low-cost apparatus that facilitates the efficient reduction of impurities that are incorporated into the overcladding silica. Thereafter, an optical fiber having improved transmission properties can be drawn from a final preform achieved using the method of the present invention.

In the specification and figures, typical embodiments of the invention have been disclosed. The present invention is not limited to such exemplary embodiments. Unless otherwise noted, specific terms have been used in a generic and descriptive sense and not for purposes of limitation.

1. A method for manufacturing an optical fiber preform possessing reduced overcladding impurities, comprising:
providing a primary preform;
overcladding the primary preform by projecting and vitrifying silica grain under a plasma torch, wherein the primary preform and/or the plasma torch move in translation with respect to each other along the longitudinal axis of the primary preform; and
during overcladding, blowing cooling gas from at least one cooling nozzle onto at least one preform zone that is adjacent to the preform zone covered by the plasma torch.

2. The method according to claim 1, wherein the step of blowing cooling gas from at least one cooling nozzle comprises blowing cooling gas onto a downstream preform zone onto which silica grain has just been vitrified, the downstream preform zone (i) being adjacent to the preform zone covered by the plasma torch and (ii) lagging the movement of the plasma torch.

3. The method according to claim 2, wherein the step of blowing cooling gas onto a downstream preform zone onto which silica grain has just been vitrified cools the downstream preform zone to a temperature below about 1300° C.

4. The method according to claim 1, wherein the step of blowing cooling gas from at least one cooling nozzle comprises blowing cooling gas onto the preform on either side of the preform zone covered by the plasma torch.

5. The method according to claim 1, wherein the step of blowing cooling gas from at least one cooling nozzle comprises blowing air.

6. The method according to claim 1, wherein the step of blowing cooling gas from at least one cooling nozzle comprises blowing nitrogen.

7. The method according to claim 1, wherein the step of blowing cooling gas from at least one cooling nozzle comprises blowing gas that has a relative humidity of less about than 10 percent at 20° C.

8. The method according to claim 1, wherein the step of blowing cooling gas from at least one cooling nozzle comprises blowing fluorinated gases and/or chlorinated gases.

9. The method according to claim 1, wherein the step of blowing cooling gas from at least one cooling nozzle comprises blowing cooling gas at a flow rate of more than about 75 l/min.

10. The method according to claim 1, wherein the step of blowing cooling gas from at least one cooling nozzle comprises blowing cooling gas at a flow rate of more than about 150 l/min.

11. The method according to claim 1, wherein at least one cooling nozzle is positioned at a lateral distance of between about 3 mm and 50 mm from the plasma torch.

12. The method according to claim 1, wherein at least one cooling nozzle is positioned at a lateral distance of between about 45 mm and 90 mm from the axis of the plasma torch.

13. The method according to claim 1, wherein, during overcladding, at least one cooling nozzle is maintained at a radial distance of between 15 mm and 60 mm from the periphery of the preform being overcladded.
